(19) United States
(12) Patent Application Publication
(10) Pub. No.: US 2026/0316876 A1
(43) Pub. Date: Oct. 15, 2026

(54) RIDING DEVICE WITH GUIDE ROD

(71) Applicant: SCOOT & RIDE HOLDING GMBH, Grieskirchen (AT)

(72) Inventor: Robert KIRCHSCHLAGER, Leonding (AT)

(73) Assignee: SCOOT & RIDE HOLDING GMBH, Grieskirchen (AT)

(21) Appl. No.: 19/485,780

(22) PCT Filed: May 17, 2024
(86) PCT No.: PCT/EP2024/063666

§ 371 Date: Nov. 19, 2025

(30) Foreign Application Priority Data
May 22, 2023 (AT) A 50393/2023

(51) Int. Cl. B62K 13/08; B62B 7/04; B62B 9/20; B62J 25/00; B62K 9/00; B62K 21/00

(52) U.S. Cl. CPC B62K 13/08; B62B 7/042; B62B 9/20; B62J 25/00; B62K 9/00; B62K 21/00

(57) ABSTRACT

A riding device for children, including a standing surface, at least one front wheel linked to the front region of the standing surface via a front carriage, at least one rear wheel linked to the rear region of the standing surface via a rear carriage. The riding device is moved in a travel direction, wherein the rear carriage and the front carriage are connected by an underframe, wherein close to the rear region of the standing surface a receiving device is arranged for receiving a rod as a guide rod, wherein the free end of the rod as a guide rod is higher than the standing surface and/or is arranged, in a projection from above, behind or above the rear wheel such that the riding device can be controlled via the rod as a guide rod by a person located behind the riding device.

### CROSS-REFERENCE TO RELATED APPLICATIONS

The present application is a national phase application of PCT Application No. PCT/EP2024/063666, filed May 17, 2024, entitled “RIDING DEVICE WITH GUIDE ROD”, which claims the benefit of Austrian Patent Application No. A 50393/2023, filed May 22, 2023, each of which is incorporated by reference in its entirety.

### BACKGROUND OF THE INVENTION

### 1. Field of the Invention

The invention relates to a vehicle for children.

### 2. Description of the Related Art

The invention relates to a vehicle for children, comprising a standing surface,
at least one front wheel linked to the front region of the standing surface via a front chassis support,
at least one rear wheel linked to the rear region of the standing surface via a rear chassis support,
said vehicle being moved in a travel direction,
wherein the at least one rear chassis support and the at least one front chassis support are connected by a chassis.

In particular, when at least two elements of standing surface, chassis supports, chassis, receiving device, brake are formed integrally, definitions of the elements given are fluid in scooters in prior art or in the subject-matter of the invention and thus not clearly distinguishable for a person of skill in the art.

For example, the vehicle may be a kickboard or a scooter. The standing surface may be formed as a chassis, which chassis establishes a steady connection between the chassis supports. The exact formation of standing surface and chassis has no bearing on the invention disclosed herein.

Such a vehicle is known from WO2017045002A1, for example.

The standing surface may, for example, be formed as a plate or other geometrical shape. Such a vehicle having a dwelling surface, and hence standing surface, formed as a plate is described, for example, in Patent Application No. PCT/EP2023/062146.

Scooters having a seating device are known in the art, a guide rod for a person located behind the scooter to control the scooter being arranged on such a seating device. For example, EP2996928A2 shows such a scooter.

CN209719703, in particular FIG. 1, discloses a scooter where a rod is arranged on the front end of the chassis via an additional console as a guide rod for a person walking behind the scooter.

FR3018260 describes a scooter having a seat attached to its steering rod. A guide rod is arranged on the free end of the seat.

CN207045546, in particular FIG. 1, and CN217260472, FIG. 8, disclose a scooter having a seat attached to its steering rod. A guide rod is attached to said seat.

Documents WO 2017193166 A1, CN 205524404 U, CN 209454926 U, DE 202011051444 U1, IT UB20155519 A1, US 2005057012 A1, CN 105539669 A, CN 103895683 B, FR 3018260 A1 show a vehicle having a receiving device forming an elevation with respect to the standing surface. There is no indication in the above documents to an integral formation of receiving device and rear wheel brake. In the said documents WO 2017193166 A1, CN 205524404 U, CN 209454926 U, DE 202011051444 U1, IT UB20155519 A1, US 2005057012 A1, CN 105539669 A, CN 103895683 B, FR 3018260 A1, the guide rod is connected to the standing surface and to the seating equipment or to another component such that there is support in two points (standing surface and seating equipment or other component).

Attaching the guide rod to the stepping surface or the chassis and another element of the vehicle such as the seating equipment has the disadvantage of the guide rod being limited to the use of said other element such as the seating equipment.

From a statics point of view, a guide rod attached to a seating device of a scooter has the disadvantage of the guide rod being attached to the seating equipment as a protruding element. Furthermore, a rod as described below may only be used as a guide rod as long as the scooter comprises a seating equipment.

### SUMMARY OF THE INVENTION

The invention disclosed herein addresses the task of attaching the guide rod to the vehicle such that the vehicle can be adapted to the abilities of the child and its correspondingly required assistance. The task involves the ability of arranging the guide rod on the vehicle in an arrangement of the elements of the vehicle for both a child standing and holding on to the holding rod and a child seated on a seating equipment.

According to the invention, this task is solved by a first solution approach, a second solution approach, or a third solution approach. Further advantageous embodiments are also disclosed.

The first solution approach is characterized by a recess as a receiving device for receiving a rod as a guide rod being arranged close to the rear region of the standing surface,
to which receiving device an attached end of the guide rod is connected and
from which receiving device the guide rod protrudes,
wherein the free end of the rod received by the receiving device as a guide rod is higher than the standing surface and/or arranged, in a projection from above, behind or above the rear wheel
such that the vehicle can be controlled by a person located behind the vehicle via the rod as a guide rod.

The second solution approach is characterized by a receiving device for receiving a rod as a guide rod being arranged close to the rear region of the standing surface,
wherein the chassis and/or the standing surface includes a recess, the receiving device extending through said recess,
wherein the free end of the rod received by the receiving device as a guide rod is higher than the standing surface and/or is arranged, in a projection from above, behind or above the rear wheel
such that the vehicle can be controlled by a person located behind the vehicle via the rod as a guide rod.

The first solution approach is partly based on the fundamental idea that a recess for arranging the receiving device is formed in the standing surface and/or the chassis. This solution approach includes the receiving device being formed by the recess in the standing surface and/or the chassis and no other workpiece for forming the receiving device being arranged in the recess.

It is achieved thanks to the recess in the standing surface that, when the guide rod is removed, the entire standing surface may be used as such. The recess for receiving or, respectively, form the recess of the receiving device should be made sufficiently small so as not to interfere. In particular, the recess should be made small enough for a child's body part not to get caught in the recess.

It is achieved by the recess in the chassis that the guide rod is introduced into a supporting element of the vehicle, which supporting element is or may become sufficiently sized as a standard element to be able to absorb the forces to be applied via the guide rod.

The first solution approach has the technical effect of the receiving device being planar with the top face of the standing surface or the top face of the chassis, respectively. The receiving device does not form an elevation with respect to the standing surface or the chassis, respectively.

The chassis extends between the at least one front wheel and the at least one rear wheel, among others. The standing surface may essentially extend across this part of the chassis and include the recess. Alternatively, the standing surface may spare the rear part of the chassis and not include a recess.

The inventive vehicle may be characterized by
the rod as a guide rod extending, in a projection from above, in parallel with a longitudinal extension axis and/or, in a lateral view, sloping upwards from its end attached to the receiving device.

The free end of the guide rod is preferably on a level where a person escorting the inventive vehicle may comfortably hold said free end.

Arranging the receiving device in the rear region of the stepping surface or chassis may be understood to mean that the receiving device is arranged in the rear half or the rearmost third or the rearmost tenth of the stepping surface and/or chassis.

The vehicle may comprise a rear wheel brake, as depicted in some of the figures. The receiving device is sufficiently spaced apart from the rear wheel brake, allowing a person to operate the rear wheel brake using their foot when a guide rod has been introduced into the receiving device.

In the solution approaches, the guide rod is connected to the stepping surface or the chassis exclusively with its attached end via the receiving device. The guide rod protrudes from the receiving device and is not connected to any other element of the vehicle. This allows using the guide rod regardless of whether a holding rod or seating equipment is provided on the vehicle.

The inventive vehicle is characterized by the receiving device being arranged adjacent to and spaced apart from a rear wheel axis of the rear wheel.

In an undisclosed inventive vehicle, the central point of the receiving device is spaced apart from the rear wheel axis by 5.0 cm. Pressing the guide rod causes the at least one front wheel to be lifted.

The inventive vehicle may be characterized by
the receiving device as well as the chassis and/or the standing surface and/or the rear chassis support being formed integrally.

The receiving device as well as the chassis and/or the standing surface and/or the rear chassis support may be made out of plastic by means of injection moulding preferably in a single process step. The elements mentioned may in this instance be produced by one process step.

The inventive vehicle may be characterized by
the receiving device being connected to the chassis and/or the standing surface and/or the rear chassis support in a mechanically releasable manner.

The figures description shows an embodiment of a receiving device. The guide rod is introduced into a recess of the receiving device.

The guide rod may be non-relocatably supported in the recess via a releasable latching device.

The attachable end of the guide rod or an adapter arranged in the same position may comprise a male thread, which male screw is screwed together with a female thread of the recess. The threads mentioned may be metric threads or other threads with a number of turns comfortable to the user.

The guide rod may also be introduced into the recess via a bayonet nut connector.

The guide rod may be introduced into the recess by applying a bias.

The inner surface of the recess and/or the attachable end of the guide rod or an adapter may be made of a malleable plastic, said malleable plastic being, for example, biased by screwing in the guide rod or adapter, respectively.

The guide rod or adapter and/or the recess may comprise a spring, said spring being biased when introducing the guide rod or the adapter into the recess.

The attachable end of the guide rod may have a conical shape, and the recess a corresponding conical shape.

The receiving device may also be connected to the standing surface and/or the chassis by clamping the standing surface or chassis to a clamping surface. Preferably, the clamping surface has an extension in the travel direction for transferring the torque forces.

The inventive vehicle may be characterized by
the guide rod being connected to the receiving device by a releasable mechanical connection.

The inventive vehicle may be characterized by
the rod comprising a handle on its free end.

The inventive vehicle may be characterized by
the mechanical connection comprising at least one actuator for releasing the mechanical connection,
said at least one actuator being arranged on the receiving device and/or on the guide rod.

The inventive vehicle may be characterized by
the vehicle comprising an additional receiving device for receiving the rod in a vertical or nearly vertical position as a holding rod in the area of the front region of the standing surface,
a child standing on the standing surface being able to hold on to said holding rod.

The invention provides for a guide rod as applied to the rear end of the vehicle, in which arrangement a person escorting the vehicle actuates the guide rod, to be arrangeable on the front end of the vehicle as well. The guide rod arrangeable on the front end of the vehicle is actuated by the person being on the vehicle, in particular by the child. The guide rod may be arranged on the front end of the vehicle in addition to a holding rod.

The inventive vehicle may be characterized by
the rod introduced into the additional receiving device as a holding rod serving as a steering actuator of a steering mechanism if the vehicle.

The inventive vehicle may be characterized by
the receiving device being formed for receiving a rod end shape and
the additional receiving device being formed for receiving an additional rod end shape,
wherein the rod end shape and the additional rod end shape are formed to be the same or different.

One end of the guide rod may include the one rod end shape, and the other end of the guide rod may include the additional rod end shape.

The inventive vehicle may be characterized by
the receiving device and/or the other receiving device being formed for releasably or non-releasably receiving at least one adapter,
which at least one adapter can be arranged between the rod and the receiving device or the additional receiving device, respectively.

The said adapter may bridge over the different rod end shapes.

The inventive vehicle may be characterized by
at least one adapter being made in multiple parts.

The inventive vehicle may be characterized by
the vehicle comprising
a holding rod or
a holding rod having a seating equipment and/or a seating/holding element, which seating/holding element is convertible from a first position as a seating equipment into a second position as a holding element.

A vehicle having a holding rod may be, for example, a scooter or kickboard.

A vehicle having a holding rod and a seating equipment is disclosed, for example, in EP2476607 and the documents listed as prior art in EP2476607.

A vehicle having a seating/holding element is described, for example, in EP3240723B1 and the documents listed as prior art in EP3240723B1.

The inventive vehicle may be characterized by
the vehicle being steerable by means of a rotary steering or a weight-shift steering or by means of a rotary weight-shift steering.

Potential examples of vehicle are given above. They may be steered by means of a rotary steering or a weight-shift steering or by means of a rotary weight-shift steering as known in the art. Should the vehicles mentioned comprise no such steering, a person of skill in the art may add such a steering to these vehicles.

The invention also relates to a guide rod or a receiving device or a combination of a guide rod and a receiving device, said guide rod or receiving device or receiving device in combination with a receiving device, respectively, being formed to be arranged on the vehicle, wherein the arrangement meets the features of the description above and/or of claims 1 to 14.

The invention also relates to a footrest to be arranged on a vehicle as described above or on a vehicle having a standing surface, at least one front wheel linked on a front chassis support in the front region of the standing surface and at least one rear wheel linked on a front chassis support in the rear region of the standing surface. The at least one rear chassis support and the at least one front chassis support are connected by a chassis.

The vehicle is moved into a travel direction. The vehicle may comprise a steering to alter the travel direction.

The inventive vehicle may be characterized by
the chassis comprising at least one chassis recess,
said chassis recess extending from a chassis top to a chassis bottom,
wherein a top footrest fastener is introduced into the chassis recess all the way to a respective stop via the chassis top and a bottom footrest fastener,
said footrest fasteners being connected by mechanical connecting means,
a footrest being arranged on said bottom footrest fastener.

The footrest fasteners may each include a stop, by which stop the introduction of the respective footrest fastener into the chassis recess is limited. It is also conceivable for the chassis recess to comprise a stop to limit the introduction of the footrest fasteners.

The at least one stop allows the footrest fasteners to be fastened in the chassis recess in a clamping manner by the connecting means.

Preferably, the footrest fasteners have a shape that fits into the chassis recess.

The footrest may be formed integrally with the bottom footrest fastener. The footrest may be arranged on the bottom footrest fastener by mechanical connecting means so as to be releasable or adjustable via a hinge. The mechanical connecting means may be, for example, a screw introduced from below via the bottom footrest fastener. The top footrest fastener may comprise a nut.

Arranging a footrest on the chassis as proposed herein is characterized by the footrest fasteners not altering the standing surface of the vehicle.

The inventive vehicle may be characterized by
the chassis being formed integrally with a top footrest fastener,
wherein a bottom footrest fastener is arranged adjacent to or adjoining the chassis bottom,
said bottom footrest fastener being connected to the top footrest fastener by mechanical connecting means,
a footrest being arranged on said bottom footrest fastener.

The chassis may comprise a chassis recess formed as a through-hole, into which chassis recess the bottom footrest fastener is introduced. The through-hole is limited on top by the footrest fastener, which footrest fastener also acts as a stop.

Preferably, the chassis recess mentioned hereinabove has a polygonal cross-section, by which cross-section twisting of the footrest fastener is prevented. This may also be achieved by forming the mechanical connecting means like guide pins to tether the bottom footrest fastener to the top footrest fastener.

### BRIEF DESCRIPTION OF THE DRAWINGS

The invention is additionally explained based on the following embodiments represented in the figures:

FIG. 1 shows a lateral view of an embodiment of the inventive scooter;

FIG. 2 shows a lateral view of another embodiment of the inventive scooter;

FIG. 3 and FIG. 4 show embodiments of the rod to use as a guide rod for use with the inventive scooter;

FIG. 5 to FIG. 7 show details of potential embodiments of the receiving device of the inventive scooter partly in connection with the rod as a guide rod;

FIG. 8 to FIG. 9 show further embodiments of the rod to use as a guide rod for use with the inventive scooter;

FIG. 10 shows details of a potential embodiment of the receiving device in connection with the rod of the inventive scooter;

FIG. 11 to FIG. 15 show further embodiments in particular of the receiving device of the inventive scooter;

FIG. 16 and FIG. 17 show embodiments of the vehicle having footrests.

### DETAILED DESCRIPTION

While the embodiments shown in the figures merely illustrate potential embodiments, it should be noted at this point that the invention is not limited to those specifically shown variant embodiments thereof, but that combinations of the individual variant embodiments with each other and of one embodiment with the overall description given above are also possible.

The scope of protection is defined by the claims. The description and the drawings, however, should be consulted in their interpretation. Individual features or combinations of features from the different embodiments shown and described may be in themselves autonomous inventive solutions. The task underlying said autonomous inventive solutions may be taken from the description.

In the figures, not all elements need to be assigned reference numerals. For clarity, no reference numeral is assigned to those included in the figures.

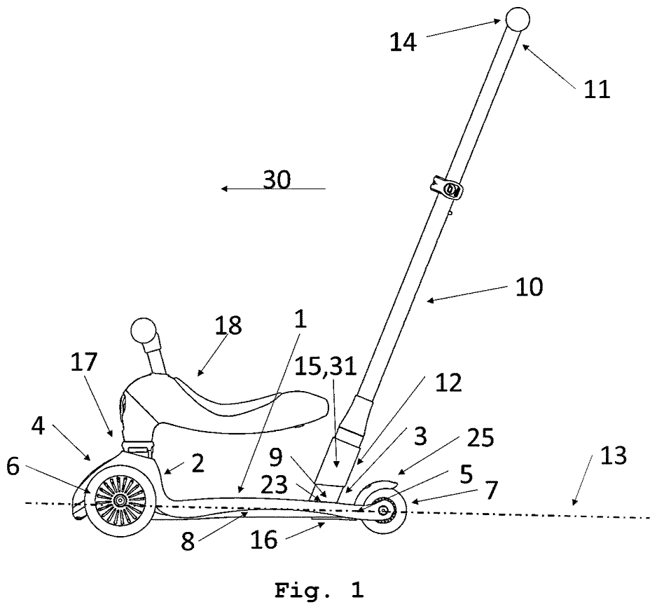

On FIG. 1:

FIG. 1 shows a view of a potential embodiment of the inventive scooter as a special case of an inventive vehicle. The vehicle may comprise, for example, a kickboard known in the art, said kickboard comprising a standing surface 1, a chassis support 4, 5 and wheels 6, 7.

The inventive vehicle comprises two front wheels 6 linked to the front region 2 of the standing surface 1 via a front chassis support 4 and a single rear wheel 7 linked to the rear region 3 of the standing surface 1 via a rear chassis support 5. Other numbers of front wheels 6 and/or rear wheels 7 are also conceivable as is known in the art for vehicles other than a kickboard. The front region 2 and the rear region 3 may be the front and rear ends, respectively, of the standing surface 1.

Furthermore, the rear chassis support 4 and the front chassis support 5 are connected by a one-piece chassis 8 without hinges arranged in the chassis. It is conceivable for the chassis 8 and the standing surface 1 to be formed integrally or as separate elements. The formation of standing surface 1 and chassis 8 has no bearing on the invention disclosed herein. Merely a steady connection between the chassis supports 4, 5 must be established.

Normally, the scooter is moved into the travel direction 30. The scooter may comprise a rear wheel 7 and two front wheels 6. The at least one front wheel 6 may be controllable via a steering mechanism. The front wheels 6 may be steerable via a weight-shift steering or a rotary steering or a rotary weight-shift steering. In addition to the elements of a typical scooter, the inventive vehicle comprises a receiving device 9. The standing surface 1 and/or the chassis 8 comprise(s), close to their rear region 3, a receiving device 9 for receiving a rod as a guide rod 10. The guide rod 10 is connected to the vehicle exclusively via the receiving device 9. The receiving device 9 allows a protruding connection of the guide rod 10 with the chassis and/or the standing surface 1.

The guide rod 10 comprises an attached end 12, said attached end 12 being attached to the receiving device 9, and a free end 11. The free end 11 of the rod as a guide rod 10 is higher than the standing surface 1 and, in a projection from above, behind the rear wheel 7 as seen in the travel direction. This arrangement of the guide rod 10, in particular of the free end 11 of the guide rod 10, with respect to the vehicle, in particular to the rear wheel 7 and the standing surface 1, is achieved by the vehicle being controllable by a person located behind the vehicle via the rod as a guide rod 10. Said person my, for example, walk behind the vehicle or at its side and hold the guide rod 10 with at least one hand. Thus, the person has the opportunity to control the vehicle.

No seat or container is arranged on the rod.

In the embodiment shown in FIG. 1, the guide rod 10 is rod-shaped and thus formed as an element extending in a straight line. The rod as a guide rod 10 extends, in particular in a projection from above, in parallel with a longitudinal extension axis 13 of the standing surface 1. The rod as guide rod 10 is sloping upwards from its end 12 attached to the receiving device. Thus, the free end 11 of the rod is higher and arranged behind the attached end 12 as seen in the travel direction.

The rod may be formed telescopically. The rod formed as a guide rod 10 may also have an arcuate or other shape not shown in FIG. 1 but equivalent to the straight shape of the guide rod 10 shown in FIG. 1.

To control in particular the direction and velocity of the vehicle via the guide rod 10, it is of advantage for the receiving device 9 to be adjacent to and spaced apart from a rear wheel axis of the rear wheel 7.

By way of example, FIG. 1 shows an embodiment in which the receiving device 9 is spaced apart from the rear wheel axis of the rear wheel 7 in the travel direction 30.

In general, two embodiments of the formation of the receiving device 9 with respect to the chassis 8 are conceivable. The receiving device 9 and the chassis 8 may, for example, be cast in one part and thus formed integrally. The receiving device 9 may also be mechanically connected to the chassis 8. This mechanical connection may be established, for example, by pin-shaped connecting means such as screws or rivets or a latching connection. In both embodiments, it is preferred for a standing surface 1 extending above the chassis 8 to include a suitable recess 23, through which recess 23 the receiving device 9 or the guide rod 10 or the adapter described below preferably extends.

The rod may comprise a handle 14 on its free end 11. While FIG. 1 shows the formation of a handle 14 as a crossbar by way of example, other shapes such as an elliptical or spheroid shape of the handle are also conceivable. The shape of the handle 14 has no immediate bearing and no technical effect on the attachment of the rod as a guide rod 10 to the chassis 8.

The rod as a guide rod 10 is preferably connected to the receiving device 9 by a releasable mechanical connection. The operator may thereby, depending on the use of the vehicle and as needed, arrange the guide rod 10 on the vehicle or remove it therefrom. Preferably, the mechanical connection comprises an actuator 15, 16 to release the mechanical connection. It is generally conceivable for the rod to comprise such an actuator 15 and/or for the receiving device to comprise such an actuator 16. Releasing the mechanical connection may require the actuation of at least one actuator 15, 16 or optionally both actuators 15, 16. Both actuators 15, 16 are shown by way of example in FIG. 1.

A vehicle for children may be characterized by the vehicle being adapted to the child's needs, in particular to its motor abilities. The embodiment shown in FIG. 1 may also allow such adaptation.

FIG. 1 shows a vehicle having a seating/holding element 18, said seating/holding element 18 being attached via an additional receiving device 17. The seating/holding element 18 supports a person in remaining on the inventive vehicle. The seating/holding element has no immediate functional connection to the receiving device 9 or a guide rod 10 introduced into the receiving device 9.

The seating/holding element 18 including the handle or the standing surface 1 may be an actuator for the weight-shift steering or the rotary weight-shift steering. In both the weight-shift steering and the rotary weight-shift steering, the vehicle is tilted, whereby the front wheels 6 are steered. Such tilting about the tilting axis of the vehicle may be achieved by actuating the guide rod.

Preferably, the vehicle comprises an additional receiving device 17 in the area of the front end 2 of the standing surface 1, which additional receiving device 17 is suitable for receiving the rod in a vertical or nearly vertical position as a holding rod 19 or steering rod, for example. A child standing on the standing surface 1 may hold on to the holding rod.

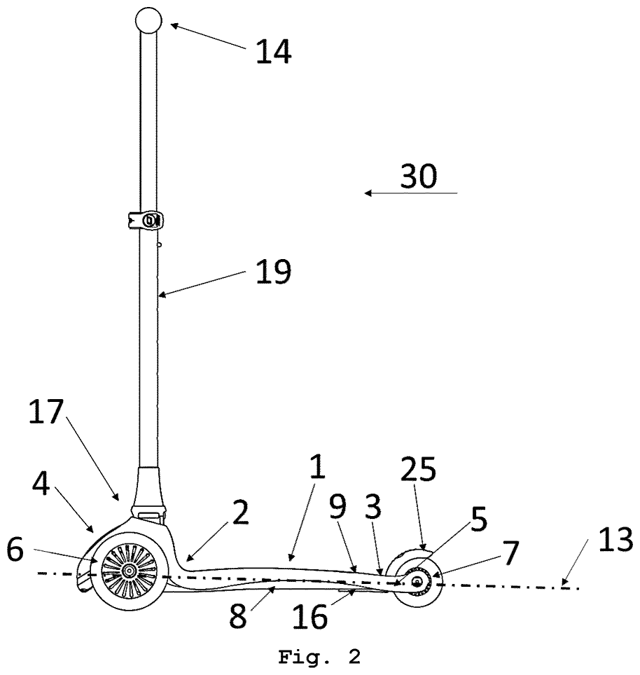

On FIG. 2:

FIG. 2 shows the vehicle having the rod as a holding device 19 introduced into the additional receiving device 17.

The vehicle may comprise, as a steering mechanism, a rotary steering or a weight-shift steering or a rotary weight-shift steering, for example. The rod introduced into the additional receiving device 17 as a holding rod may serve as a steering actuator of a steering mechanism of the vehicle.

The guide rod 10 introduced into the receiving device 9 may also serve as an actuator of the steering mechanism of the vehicle. The person dwelling behind the vehicle may thus steer the vehicle. Since the embodiment shown in FIG. 2 comprises the receiving device 9 on the rear end 3 of the standing surface, the embodiment shown in FIG. 2 is novel to the known prior art.

The scooter shown as the inventive vehicle in FIG. 1 and FIG. 2 may be characterized by the ability to introduce the rod into the receiving device 9 as a guide rod 10 or into the additional receiving device 17 as a holding rod 19. To the latter end, the rod as a guide rod 10 (see FIG. 1) is removed from the receiving device 9 and introduced into the additional receiving device 17 (see FIG. 2). Preferably, the receiving device 9 without the guide rod 10 introduced forms no elevation in the standing surface 1 such that the entire surface of the standing surface 1 can be used. The empty receiving device 9 may form a recess in the standing surface 1, which recess may be made so as to be releasable.

Scooters in the art comprise the additional receiving device 17.

If the end 12 of the rod to be attached cannot be introduced into the receiving device 9 and into the additional receiving device 17, a person of skill in the art may provide one or more adapters 38 for introduction into the additional receiving device 17 or into the receiving device 9. FIG. 1 and FIG. 2 show the special case in which the rod as a guide rod 10 is introduced into the receiving device 9 with a first adapter or, respectively, as a holding rod 19 into the additional receiving device 17 without an adapter or with a second adapter. The reverse solution is also conceivable.

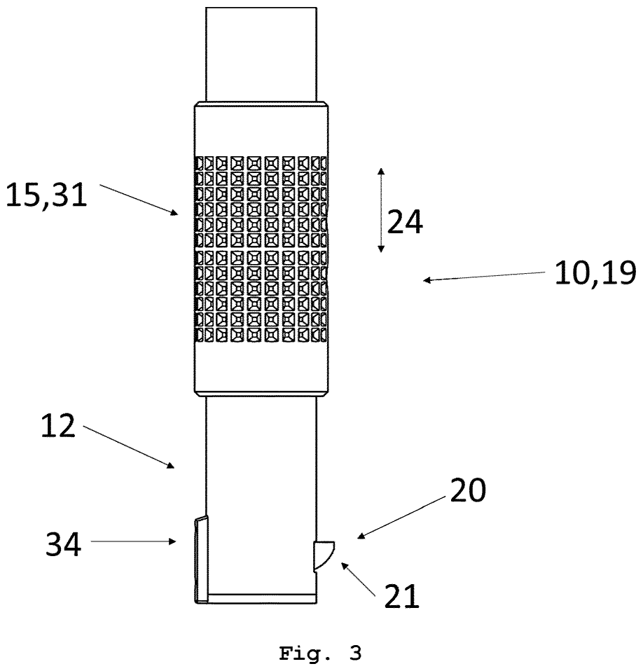

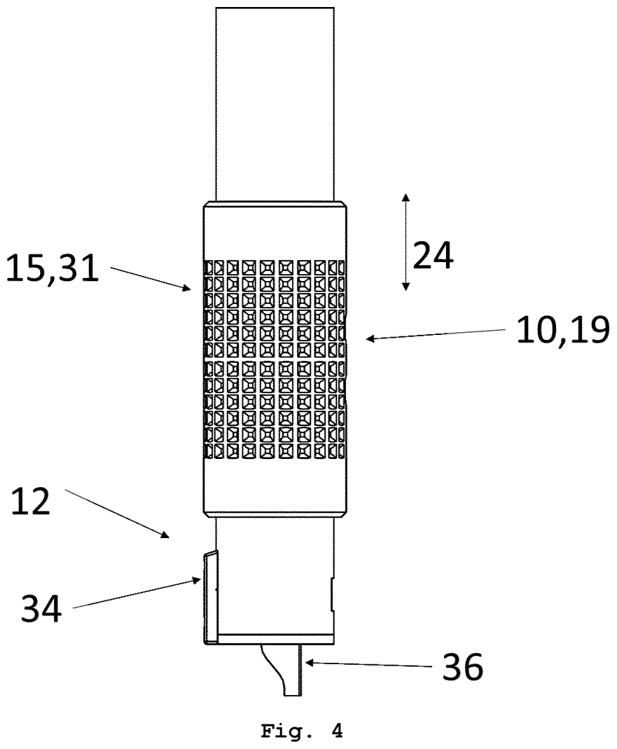

On FIG. 3 and FIG. 4:

FIG. 3 shows a view of a potential embodiment of the attached end 12 of the rod.
FIG. 3 shows a potential embodiment of the attached end 12 of the rod without a detachable adapter.

The rod shown in FIG. 3 may be used as a guide rod 10 and/or as a holding rod 19. It has been mentioned above that the rod as a guide rod 10 may be connected to the receiving device 9 by mechanical connecting means. A potential embodiment of said releasable mechanical connecting means is shown in FIG. 3.

The rod comprises, on its attached end 12, a latch element 20. The latch element 20 can be moved between an extended position shown in FIG. 3 and a retracted position shown in FIG. 4. A spring preferably provided in the rod (not included in FIG. 3) drives the latch element 20 into the extended position shown in FIG. 3 and thus into a latching recess 22 of the recess 23 of the standing surface 1 included in FIG. 6.

In an advantageous manner, the embodiment shown in FIG. 3 comprises a guiding element 34. The guiding element 34 is formed as protrusion herein by way of example, said protrusion being introduced into a corresponding guide recess 35 in the recess shown in FIG. 6. The guiding element 34 introduced may also prevent the guide rod 10 from being twisted about its longitudinal axis.

As an alternative to the guiding element 34 introduced into the guide recess 35, a person of skill in the art may also choose an oval cross-section of the rod and a fitting recess 23 to prevent the guide rod 10 from rotating about its longitudinal axis.

The rod is thus formed for being introduced into a fitting recess 23 of the receiving device 9.

Preferably, the latch element 20 includes an oblique or rounded surface 21 on that side edge thereof that is closer to the attached end, said surface 21 causing the latch element 20 to be retracted when the rod is introduced without user activity into the recess 23 of the receiving device 9 not shown in FIG. 3. The receiving device 9 includes a latching recess 22, the latch element 20 being introduced into said latching recess 22 to fix the rod in the receiving device 9.

The end shown in FIG. 3 comprises a handle 31. In an advantageous manner, the handle 31 is formed as an actuator 15. In an advantageous manner, the actuator 15 is coupled to the latch element 20 such that pushing the actuator 15 into one of the directions 24 causes the actuator 15 from the extended position (see FIG. 3) into the retracted position (see FIG. 4), optionally against spring force. For example, moving the actuator 15 as shown in FIG. 3 and FIG. 4 downwards may cause retraction of the latch element 20. In such an embodiment, the handle 31 as an actuator 15 must be moved up or down to move the latch element 20 out of the latching recess 22 and thus be able to release the attached end 12 from the receiving device 9.

It can be seen from FIG. 1 that the guide rod 10 is inclined backwards such that the handle 14 is arranged, in a projection from above, behind and above the rear wheel 7. A user who wants to remove the guide rod 10 from the receiving device 9 should remove the guide rod 10 in a direction parallel to the inclination of the guide rod 10. It may be assumed, however, that the user removes the guide rod 10 in a vertical direction and thus deviating from the required removal direction, which may cause wedging or damaging of the receiving device 9 and/or the attached end 12.

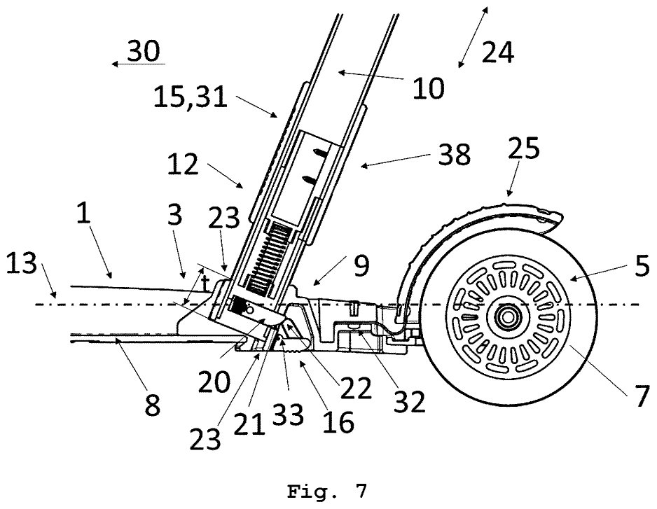

In an advantageous manner, the rod comprises a drive-out element 36 on its attached end 12, said drive-out element 36 being mechanically coupled to the actuator 15. FIG. 3 does not show a drive-out element 36 as the drive-out element 36 is in a retracted position. FIG. 4 shows the drive-out element 36 in the extended position. When the recess 23 of the receiving device 9 is formed as a through-hole at least in partial regions, the drive-out element 36 is pressed against the through-hole, causing the rod introduced into receiving device 9 as a guide rod 10 to be lifted by the height of the drive-out element 36 in its extended position. Height h of the drive-out element 36 in its extended position may equal depth t (see FIG. 7) of the recess 23 formed as a through-hole.

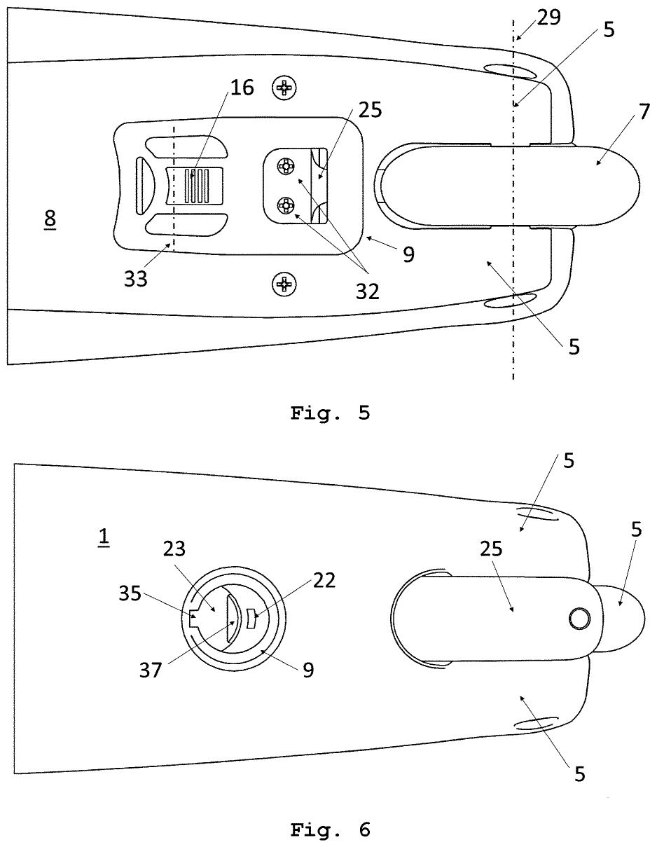

On FIG. 5:

FIG. 5 shows a bottom view of the inventive vehicle. FIG. 5 shows the special case in which the receiving device 9 is connected to the bottom of the chassis 8 with screws 32. Preferably, the screws 32 are the screws used to apply the brake 25 to the standing surface 1 and/or the chassis 8 in a scooter known in the art. As an alternative to screws 32, latching connections are also conceivable.

The brake 25 can be partly discerned in FIG. 5.

As an alternative to this mechanical connection of the receiving device 9, an integral formation of receiving device 9 and chassis 8 and/or rear chassis support 5 is also conceivable.

The standing surface 1 and the chassis 8 comprise a recess 23 not shown in FIG. 5, the rod being placed through said recesses 23 as a guide rod 10. FIG. 6 shows a top view on the rear region 3 as the rear end of the standing surface 1, the recess 23 being visible. The recess 23 cannot be seen in FIG. 5 since the recess 23 is formed as a through-hole in an advantageous manner.

FIG. 5 shows an actuator 16 arranged on the receiving device 9 for driving the latch element 20 out of the latching recess 22 of the receiving device 9. Preferably, the actuator 16 is supported so as to rotate about an actuator axis 33 such that the actuator 16 acts as a mechanical lever, allowing the latch element 20 to be brought into its retracted position against the spring force of the spring to release the rod (see also FIG. 7).

On FIG. 6:

FIG. 6 shows a top view of the rear end of the inventive embodiment of the scooter shown in FIG. 5. The recess 23 in the standing surface 1 and in the chassis 8 is clearly visible, the attached end 12 of the rod being introduced into said recess 23. FIG. 6 shows the special case in which the recess 23 is made such that the receiving device 9 extends from the bottom side (see FIG. 5) all the way to the surface of the standing surface 1.

Furthermore, the latching recess 22 is visible in the recess 23 made as a bore herein by way of example. When introducing the attached end 12 of the rod, the latch element 20 is introduced into said latching recess 22.

Furthermore, the guide recess 35 can be discerned, said guide recess 35 being arranged on the opposite side of the recess 23 herein by way of example. The guide recess 35 has a cross-section that geometrically fits the guiding element 34 shown in FIG. 3 and FIG. 4, allowing the guiding element 34 to be introduced into the guide recess 35 to guide the rod. By way of example, the guide recess 35 and guiding element 34 have a rectangular cross-section.

Furthermore, it can be seen from FIG. 6 that the recess 23 is formed as a through-hole having a through-hole recess 37. The through-hole recess 37 is arranged on the deepest point of the recess 23 and guarantees the drain of any water accumulated in the recess 23.

The receiving device 9 may be formed integrally with the chassis 8. Since this is merely a potential embodiment, no reference numeral 8 is included for the chassis 8 in FIG. 6.

On FIG. 7:

FIG. 7 shows a sectional view of the rear end of the embodiment of the inventive vehicle shown in FIG. 5 and FIG. 6, in particular of the rod end discussed above.

To release the rod as a guide rod 10 from the receiving device 9, the actuator 16, which is supported so as to rotate about an actuating rotational axis 33, is pressed on its free end and thus rotated about said actuating rotational axis 33. This movement causes the latch element 20 to be pushed out of the latching recess 22 of the receiving device 9.

In addition or as an alternative to actuating the actuator 16, actuating the actuator 15 may also cause the latch element 20 to move from the extended position into a retracted position as described above with regard to FIG. 3 and FIG. 4. In the retracted position, the attached end 12 is released.

In an advantageous manner, the handle 31 also acts as an actuator 15 in FIG. 7.

The receiving device 9 is essentially planar with the standing surface 1 of the inventive vehicle. The entire surface extending between the front wheel 6 and the rear wheel 7 may be used as the standing surface 1. The recess 23 may be made sufficiently small.

The embodiment of the receiving device 9 shown in FIG. 7 allows an arrangement in which the guide rod 10 protrudes from the standing surface 1 and/or the chassis.

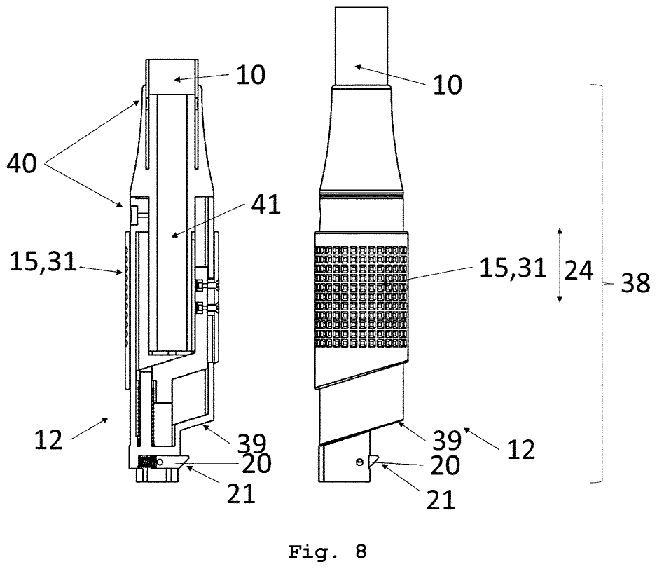

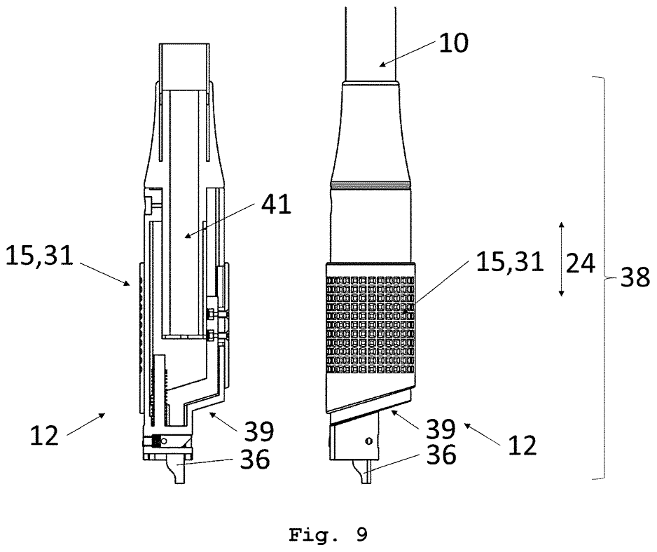

On FIG. 8 and FIG. 9:

FIG. 8 and FIG. 9 show sectional views and views of another embodiment of the attached end 12 of the rod. In contrast to the embodiment shown in FIG. 3 and FIG. 4, the attached end 12 is formed by at least one adapter 38, said adapter being releasably or non-releasably connected to the rod. The at least one adapter 38 may, for example, be attached to the rod via a screwed connection 40 or a mechanical connection of the like.

The adapter 38 may comprise multiple parts.

To use the rod as a guide rod 10 and to introduce the guide rod 10 into the receiving device 9, the at least one adapter is mounted on the rod. To use the rod as a holding rod 19 and to introduce the holding rod 19 into the additional receiving device 17, the at least one adapter 38 is taken off the holding rod 19. By taking the at least one adapter 38 off, another end 41 of the rod is released, which other end 41 can be introduced into the additional receiving device 17.

FIG. 8 shows a view and a sectional view of the attached end 12 of the rod in a state suitable for being introduced into the receiving device 9. FIG. 9 shows a view and a sectional view of the free end 12 of the rod in a state for being removed from the receiving device 9.

Likewise to the embodiment shown in FIG. 3 and FIG. 4, this embodiment also comprises a biased latch element 20 preferably having an oblique surface 21. In an advantageous manner, the rod comprises an actuator 15. By relocating 24 the actuator 15 formed as a handle 31 in parallel with the rod, the latch element 20 is converted from the extended position shown in FIG. 8 into the retracted position shown in FIG. 9. Preferably, the actuator 15 is moved during said conversion from the position shown in FIG. 8 into the position shown in FIG. 9 while biasing a spring.

In the inventive vehicle, which comprises an actuator 15 on the rod and/or an actuator 16 on the receiving device 9, the rod as a guide rod 10 may be released by the actuator 15 and/or by the actuator 16. In an advantageous manner, the latch element 20 is brought into a position projecting away from the end face of the free end 12 (see FIG. 9), thereby moving a rod introduced into the receiving device 9 out of the receiving device 9. The above description is based on the idea that the receiving device 9 is attached to the chassis 8 and/or the standing surface 1 and/or the rear chassis support 5.

In a manner similar to the embodiment shown in FIG. 3 and FIG. 4, the embodiment shown in FIG. 8 and FIG. 9 comprises a drive-out element 36. The relevant description, in particular of the drive-out element 36, in the above figures description applies to the current figures description as well.

The drive-out element 36 may offer the advantage of the rod as a guide rod 10 being driven out of the receiving device 9 into the right direction. The drive-out element 36 may offer the particular advantage of the rod as a guide rod 10 not being pulled out of the receiving device 9 into a wrong direction.

The embodiment shown in FIG. 8 and FIG. 9 comprises an attached end 12 formed as a tapered end. The tapered formation of the attached end 12 creates a support region 39, which support region 39 contacts, for example, the standing surface 1 or another element of the vehicle when the rod is introduced into the receiving device 9. This provides for advantageous support of the rod as a guide rod 10.

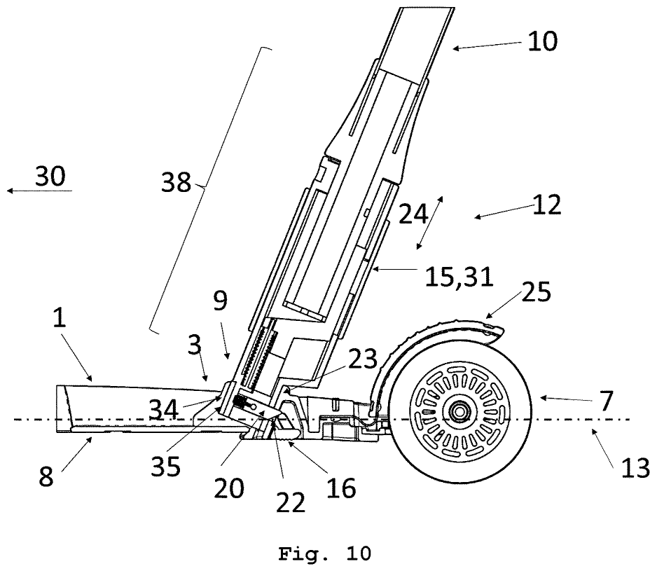

On FIG. 10:

FIG. 5 and FIG. 6, which show a bottom view and a top view of the chassis 8 and the standing surface 1, respectively, are described above in the context of a rod without an adapter. FIG. 5 and FIG. 6 are applicable to the embodiment of the attached end 12 of the rod having at least one adapter 38 as shown in FIG. 8 and FIG. 9.

FIG. 10 shows a sectional view of the rear part of an embodiment of the inventive scooter. The rod having at least one adapter 38 is introduced into the receiving device 9 as a guide rod 10. The guide rod 10 is arranged so as to protrude.

Again, the receiving device 9 is essentially planar with the standing surface 1. The recess 23 should be made sufficiently small so as not to interfere.

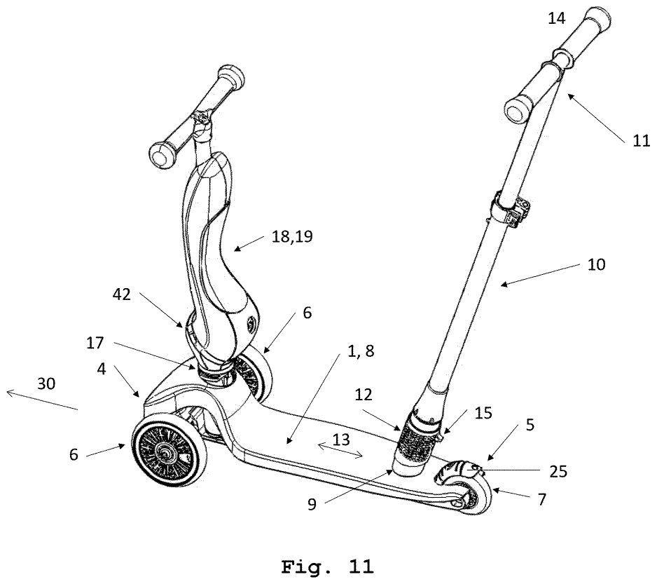

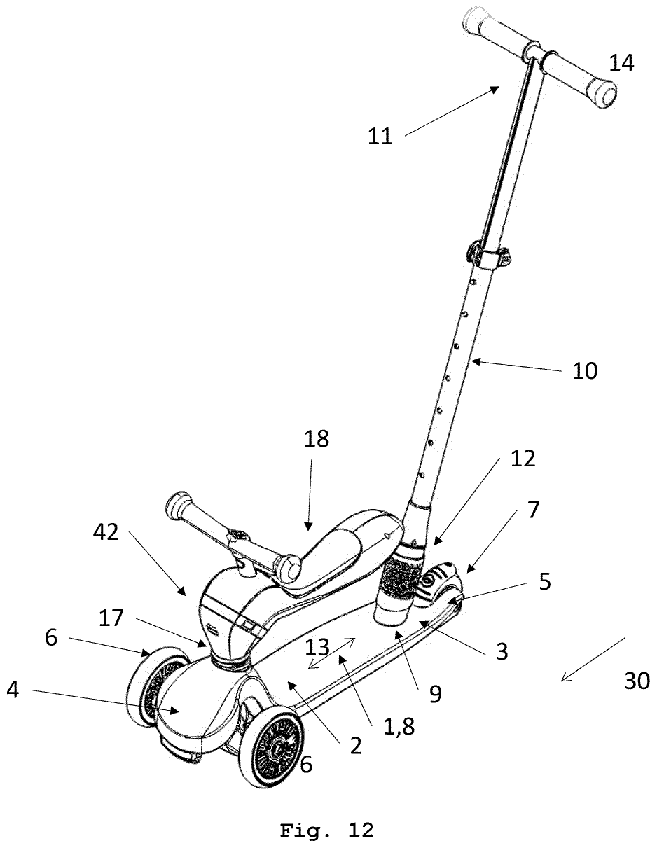

On FIGS. 11, 12:

FIG. 11 and FIG. 12 show a prototype of an inventive vehicle. The features of the vehicles shown in FIG. 11 and FIG. 12 may be derived clearly and directly from the above description.

The vehicle comprises a standing surface 1. A chassis 8 is arranged under the standing surface 1. The standing surface 1 may be formed either by a part covering or cloaking the chassis 8 or integrally with the chassis 8. A front chassis support 2 is arranged on the front end of the standing surface 1 or the chassis 8 and a rear chassis support 3 is arranged on the rear end of the standing surface 1. The front chassis support 4 carries two front wheels 6 and the rear chassis support 5 carries one rear wheel 7.

Preferably, the front wheels 6 can be steered by a steering. The steering may be a weight-shift steering or a rotary weight-shift steering or a rotary steering.

The vehicle further comprises a seating/holding element 18 known according to the current teaching. FIG. 11 shows it in its position as a holding rod. FIG. 12 shows it in its position as a seating element. The seating/holding element 18 may act as an actuator for steering the front wheels 6.

The vehicle further comprises a guide rod 10, said guide rod 10 being releasably mechanically connected to the standing surface 1 and the chassis 8 as explained above. FIG. 11 and FIG. 12 show a connection without an adapter. The connection may also be established via an adapter as explained above.

The guide rod 10 is attached to the chassis 8 and/or the standing surface 1 via the receiving device 9. Preferably, there is enough room between the receiving device 9 and the front end 2 of the standing surface 1 for a child to stand between the front end 2 of the standing surface 1 and the guide rod 10 introduced.

The guide rod 10 comprises, on its free end 11, a handle 14. The handle 14 is shown herein as a crossbar by way of example. Alternatively, a spheroid end is conceivable.

The guide rod 10 also acts as an actuator for the steering. The person escorting the vehicle may slant the vehicle using the guide rod 10 and thus cause the front wheels 6 to be steered by a weight-shift steering or a rotary weight-shift steering. This person may also effect a rotating movement of the vehicle about the rear wheel 7 and thus cause the front wheels 6 to be steered by a rotary steering or a rotary weight-shift steering. A person of skill in the art may choose a suitable end for the free end 11 of the guide rod 10 such that the guide rod 10 can act as an actuator for the steering.

The seating/holding element 18 has no connection with the guide rod 10. The seating/holding element 18 does not contact the guide rod 10. The seating/holding element 18 is spaced apart from the guide rod 10 in any position.

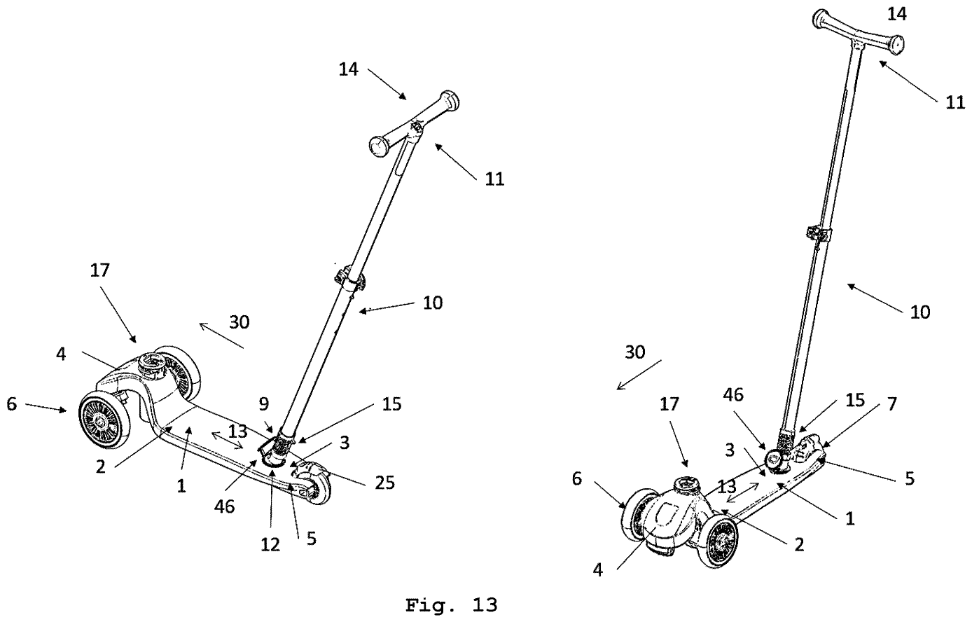

On FIG. 13:

FIG. 13 shows a slant rear view (left side of FIG. 13) and a view from the front at an angle (right side of FIG. 13) of the inventive vehicle. In contrast to the depictions in FIG. 11 and FIG. 12, the vehicle depicted in FIG. 13 does not comprise a seating/holding element. The guide rod 2 as described above may also be introduced into the additional receiving device 17 in the front region of the vehicle.

The guide rod 10 is formed as a telescopic rod. The guide rod 10 comprises a handle 14 on its free end 11, said handle 14 allowing a person located behind the vehicle to push and steer the vehicle. FIG. 13 shows an A-arm as an example of a handle.

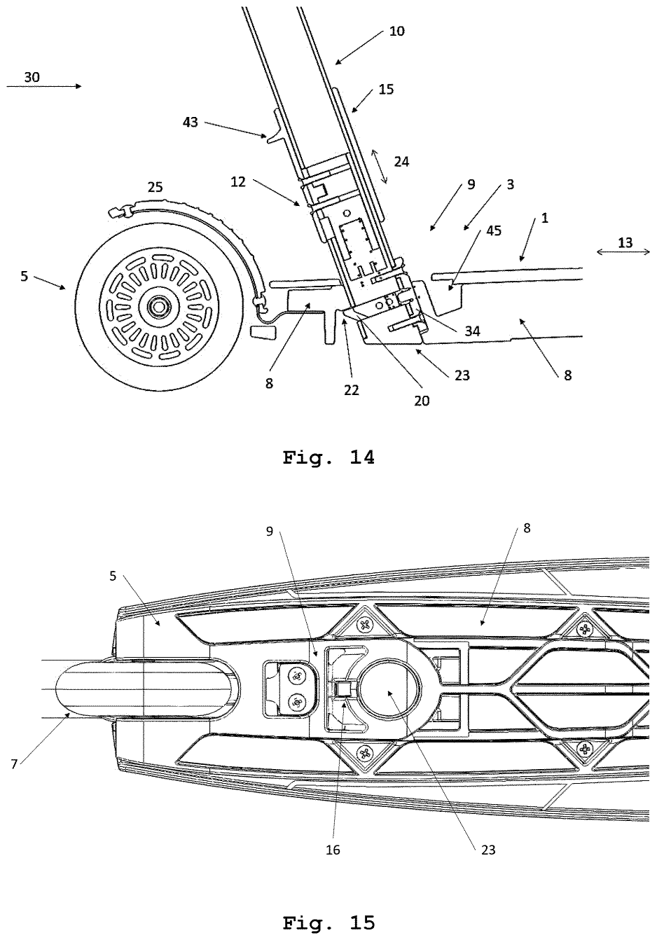

On FIG. 14:

FIG. 14 shows, in particular as an addition to FIG. 10, a sectional view of the guide rod 10 introduced into the standing surface 1. The feature discussed in this context differ from those in FIG. 10.

The vehicle for children shown comprises a standing surface 1, at least one front wheel linked on a front chassis support 4 in the front region of the standing surface 1 (not shown in FIG. 14), at least one rear wheel 7 linked on a rear chassis support 4 in the rear region of the standing surface 1, wherein the vehicle is moved in a travel direction 30. The at least one rear chassis support 5 and the at least one front chassis support 4 are connected by a chassis 8.

Close to the rear region of the standing surface 1, a recess 23 is arranged as a receiving device 9 for receiving a rod as a guide rod 10, wherein the above definitions apply in interpreting the term ‘close’.

While the recess 23 in the embodiment shown in FIG. 14 is formed in the standing surface 1 and the chassis 8, it would also be conceivable to form the recess only in the cover element forming the standing surface 1 or only in the chassis 8. The recess 1 formed in the standing surface 1 and the chassis 8 is functionally formed like the receiving device 1 in the embodiment shown in FIG. 1.

An attached end 12 of the guide rod 10 is connected to the receiving device 9. The guide rod 10 protrudes from said receiving device 9, the free end 11 of the rod received by the receiving device 9 as a guide rod 10 being higher than the standing surface 1 and/or arranged, in a projection from above, behind or above the rear wheel 7. The vehicle can thus be controlled via the rod as a guide rod 10 by a person located behind the vehicle.

The guide rod 10 is fastened to the vehicle exclusively via the receiving device 9. The receiving device 9 is arranged adjacent to and spaced apart from a rear wheel axis of the rear wheel 7, reference being again made to the definitions above for interpreting the term ‘close’.

The receiving device 9 as well as the chassis 8 and the standing surface 1 and the rear chassis support 5 are formed integrally in this preferred embodiment of the inventive vehicle.

The guide rod 10 is connected to the receiving device 9 by a releasable mechanical connection. A latching recess 22 is formed in the chassis support 8. The latching device 20 arranged on the guide rod 10 can be releasably introduced into the latching recess 22.

The vehicle may comprise an additional receiving device 17. The receiving device 9 and/or the additional receiving device 17 may be formed for the releasable or non-releasable reception of at least one adapter, said at least one adapter being formed in one part or multiple parts and arrangeable between the rod and the receiving device 9 or the additional receiving device 17, respectively.

The vehicle may be characterized by the vehicle comprising a holding rod or a holding rod having a seating equipment and/or a seating/holding element 18, said seating/holding element 18 being convertible from a first position as a seating equipment into a second position as a holding element.

The vehicle may be steerable by means of a rotary steering or a weight-shift steering or by means of a rotary weight-shift steering.

The actuator 15 additionally includes an actuator projection 43, said actuator projection 43 being arranged in the rear region of the actuator 15. Other shapes such as, for example, a shape of the actuator projection 43 circulating the actuator 15 are conceivable. The actuator projection 43 may allow actuating the actuator 15 using one's foot.

The guide rod 10 has an oblique attached end 12 such that the attached end 12 lines up with the bottom of the chassis 8. The guide rod 10 is protrudingly attached to the chassis 8 and/or the standing surface 1.

A cavity 45 is formed upstream of the receiving device 9 as seen in the travel direction 44. The recess 23 of the receiving device 9 may be sealed with a sealing part 46 that is preferably elastic (not shown in FIG. 14; see FIG. 13). The sealing part 46 may be anchored in the chassis 8 and/or the standing surface 1 and articulated due to its preferably elastic formation.

On FIG. 15:

FIG. 15 shows multiple views of the inventive vehicle. The receiving device 9 is integrated into the chassis 8 and connected thereto by screws. The receiving device 9 further comprises an actuator 16. The actuator 12 of the guide rod 10 and/or the actuator 13 of the receiving device 9 may be actuated to release the guide rod 10.

The recess 23 extends through the chassis 8 and/or the standing surface 1.

The receiving device 9 described in this disclosure of the invention is characterized by the guide rod 10 being connected to the vehicle exclusively via said receiving device 9.

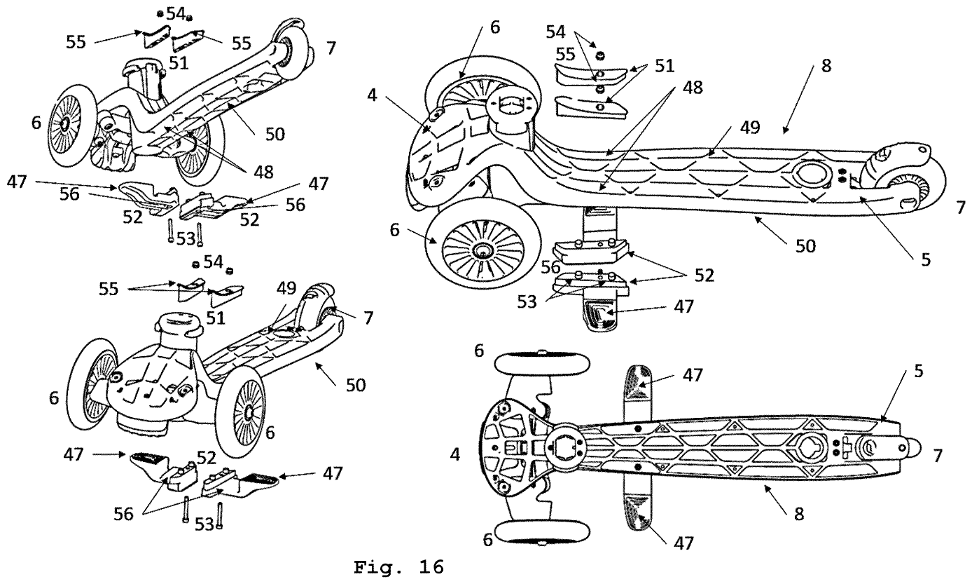

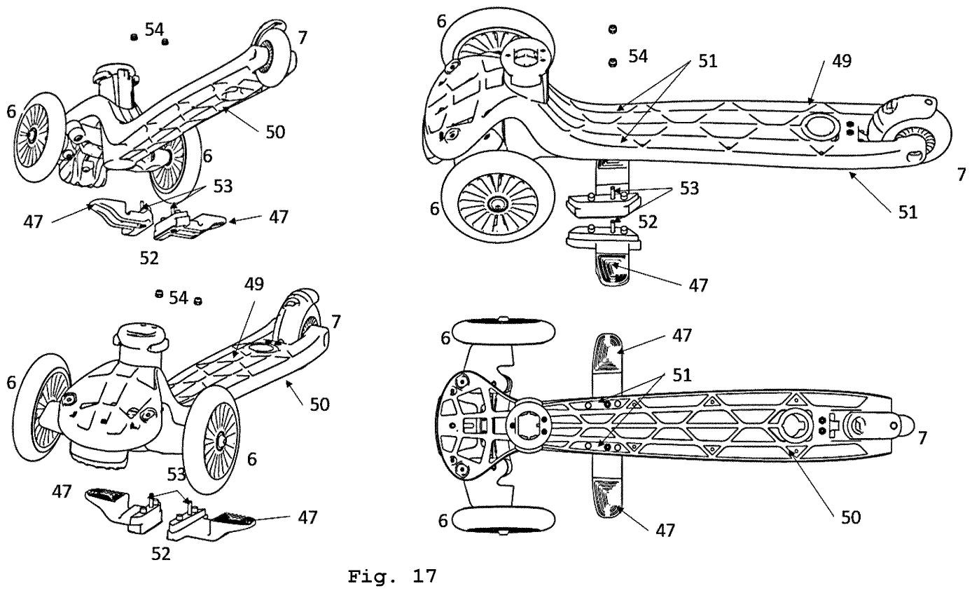

On FIG. 16:

FIG. 16 shows views of an addition to the inventive vehicle: footrests. The footrests 47 described below may also be comprised by a vehicle, in particular for children, having a standing surface 1, at least one front wheel linked on a front chassis support 4 in the front region of the standing surface 1 (not shown in FIG. 14), at least one rear wheel 7 linked on a rear chassis support 4 in the rear region of the standing surface 1, wherein the vehicle is moved in a travel direction 30. The at least one rear chassis support 5 and the at least one front chassis support 4 are connected by a chassis 8.

The vehicle is moved in a travel direction 30 and may comprise a steering according to the current teaching for altering the travel direction 30.

The embodiment shown in FIG. 16 relates to an add-on kit for arranging footrests 47 on a vehicle such as, for example, a kickboard known in the art. Such a vehicle comprises a chassis 8 of a skeleton structure. The chassis 8 comprises chassis recesses 48, said chassis recesses 48 extending from the chassis top 49 to the chassis bottom 50. FIG. 16 shows the special case in which the cross-section of the chassis recesses 48 is invariable. A variable cross-section of the chassis recesses 48 is conceivable albeit not shown in FIG. 16.

A top footrest fastener 51 is introduced into the chassis recess 48 via the chassis top 49. The top footrest fastener 51 has a shape that fits the chassis recess 48. The top footrest fastener 51 may fill the chassis recess 48 completely.

A bottom footrest fastener 52 is introduced into the chassis recess 48 via the chassis bottom 48. The bottom footrest fastener 52 has a shape that fits the chassis recess 48. The bottom footrest fastener 52 may fill the chassis recess 48 completely.

The footrest fasteners 52, 53 each have a stop 55, 56 for limiting the introduction depth.

The footrest fasteners 51, 52 are kept non-relocatable in their positions with respect to each other as introduced into the chassis recess 48 by connecting means and by the stops 55, 56. The connecting means may be connecting means connecting the footrest fasteners 51, 52 such as a screw or a snap-lock connection (not shown in FIG. 16) connecting the footrest fasteners 51, 52. It is also conceivable for the footrest fasteners 51, 52 to be connected to each other by the chassis 8 (not shown in FIG. 16).

FIG. 16 shows the screw 53 and a nut 54 forming a counter-thread, said nut 54 being introduced into the top footrest fastener 51. It is also conceivable for a self-cutting screw 53 to be introduced into the top footrest fastener 51.

The bottom footrest fastener 52 can be released from the top footrest fastener 51 and thus from the chassis 8 by loosening the screw 53.

A footrest 47 is releasably or non-releasably or adjustably arranged on the preferably bottom footrest fastener 52. FIG. 16 shows the special case of the non-releasable arrangement of the footrest 47 on the bottom footrest fastener 52, the footrest 47 and the bottom footrest fastener 52 being formed integrally. It is also conceivable for the footrest 47 to be arranged on the bottom footrest fastener 52 so as to be releasable or adjustable via a hinge.

A standing surface 1 is formed on the chassis top 49. The footrest 47 is formed at the side of the standing surface 1 and makes it wider. A light-weight child may thus actuate the weight-shift steering via the footrests 47.

The standing surface 1 is not made smaller by the footrest 47 being arranged on the chassis 8.

The system of top footrest fastener 51 and bottom footrest fastener 52 shown in FIG. 16 allows the retroactive arrangement of elements such as the footrest 47 or other elements on the chassis 8.

FIG. 17 shows another embodiment for arranging a footrest 47 or another element on the chassis 8. The chassis 8 comprises a top footrest fastener 51 formed integrally with the chassis 8. A bottom footrest fastener 52 is connected to the top footrest fastener 51 by mechanical connecting means such as a screw 53. Thus, the footrest 47 arranged on the bottom footrest fastener 52 is applied to the chassis 8 without altering the standing surface 1. The footrest 47 may be non-releasably or releasably or adjustably applied to the bottom footrest fastener 52.

### LIST OF REFERENCE NUMERALS

In the figures, the following elements are designated by preceding reference numerals. For clarity, not all elements in the figures are always designated by reference numerals.
1 standing surface
2 front end (of standing surface)
3 rear end (of standing surface)
4 front chassis support
5 rear chassis support
6 front wheel
7 rear wheel
8 chassis
9 receiving device
10 guide rod
11 free end (of rod)
12 attached end (of rod)
13 longitudinal extension axis (of standing surface)
14 handle (of rod)
15 actuator (of rod)
16 actuator (of receiving device)
17 additional receiving device
18 seating/holding element
19 steering rod
20 latch element
21 oblique surface (of latch element)
22 latching recess
23 recess in standing surface, chassis
24 shifting direction of actuator
25 brake
26 lug (of brake)
27 rivet
28 recess
29 rear wheel axis
30 travel direction
31 handle
32 screws
33 actuator rotational axis
34 guiding element
35 guide recess
36 drive-out element
37 through-hole recess
38 adapter
39 support region
40 adapter's screwed connection
41 additional end
42 hinge
43 actuator projection
44 (not assigned)
45 cavity
46 sealing part

1-15. (canceled)

16. A vehicle for children, comprising
a standing surface;
at least one front wheel linked to a front region of the standing surface via a front chassis support;
at least one rear wheel linked to a rear region of the standing surface via a rear chassis support, the vehicle configured to move in a travel direction;
wherein the at least one rear chassis support and the at least one front chassis support are connected by a chassis;
wherein close to the rear region of the standing surface a recess is arranged as a receiving device for receiving a guide rod, an attached end of the guide rod being connected to the receiving device, the guide rod protruding from the receiving device; and
wherein the free end of the rod received by the receiving device as a guide rod is higher than the standing surface and/or is arranged, in a projection from above, behind or above the rear wheel so that the vehicle can be controlled via the guide rod by a person located behind the vehicle.

17. A vehicle for children, comprising
a standing surface;
at least one front wheel linked to a front region of the standing surface via a front chassis support;
at least one rear wheel linked to a rear region of the standing surface via a rear chassis support, the vehicle configured to move in a travel direction;
wherein the at least one rear chassis support and the at least one front chassis support are connected by a chassis;
wherein close to the rear region of the standing surface a receiving device is arranged for receiving a guide rod, wherein at least one of the chassis and the standing surface includes a recess, the receiving device extending through the recess;
wherein a free end of the guide rod received by the receiving device is at least one of:
higher than the standing surface, and
arranged, in a projection from above, behind or above the rear wheel; and
wherein the vehicle can be controlled via the guide rod by a person located behind the vehicle.

18. The vehicle of any one of claims 16 and 17, wherein the receiving device is arranged adjacent to and spaced apart from a rear wheel axle of the rear wheel.

19. The vehicle of any one of claims 16 and 17, wherein one of:
the receiving device is formed integrally with at least one of the chassis, the standing surface, and the rear chassis support; and
the receiving device is mechanically connected to at least one of the chassis, the standing surface, and the rear chassis support.

20. The vehicle of any one of claims 16 and 17, wherein the guide rod is connected to the receiving device by a releasable mechanical connection.

21. The vehicle of any one of claims 16 and 17, wherein:
the vehicle comprises, in an area of the front region of the standing surface, an additional receiving device for receiving the guide rod in a vertical or nearly vertical position as a holding rod; and
a child standing on the standing surface is able to hold on to the holding rod.

22. The vehicle of claim 21, wherein the rod introduced into the additional receiving device as a holding rod serves as a steering actuator of a steering mechanism of the vehicle.

23. The vehicle of claim 21, wherein:
the receiving device is formed for receiving a rod end shape; and
the additional receiving device is formed for receiving an additional rod end shape

24. The vehicle of claim 23, wherein the rod end shape and the additional rod end shape are different.

25. The vehicle of claim 21, wherein:
at least one of the receiving device and the additional receiving device are formed to releasably or non-releasably receive at least one adapter; and
the at least one adapter is arrangeable between the rod and the receiving device or the additional receiving device, respectively.

26. The vehicle of claim 25, wherein the at least one adapter is made in multiple parts.

27. The vehicle of any one of claims 16 and 17, further comprising one of:
a holding rod; and
a holding rod having at least one of a seating equipment and a seating/holding element, the seating/holding element configured to be converted from a first position as a seating equipment into a second position as a holding element.

28. The vehicle of any one of claims 16 and 17, wherein the vehicle is configured to be steered by one of a rotary steering, a weight-shift steering, and a means of a rotary weight-shift steering.

29. A guide rod, formed to be arranged on a vehicle of any one of claims 16 and 17.

30. A footrest, formed to be arranged on a vehicle of any one of claims 16 and 17, wherein:
the chassis comprises at least one chassis recess, the chassis recess extending from a chassis top to a chassis bottom;
a top footrest fastener is introduced into the chassis recess all the way to a respective stop via the chassis top and a bottom footrest fastener;
the footrest fasteners being connected by mechanical connecting means; and
a footrest being arranged on said bottom footrest fastener.

31. A footrest, formed to be arranged on a vehicle of any one of claims 16 and 17, wherein:
the chassis is formed integrally with a top footrest fastener;
a bottom footrest fastener is arranged adjacent to or adjoining the chassis bottom;
the bottom footrest fastener being connected to the top footrest fastener by mechanical connecting means; and
a footrest is arranged on the bottom footrest fastener.
